(19) United States
(12) Patent Application Publication
(10) Pub. No.: US 2009/0103098 A1
(43) Pub. Date: Apr. 23, 2009

(54) Method and Composition for Identification

(76) Inventors: Douglas Stanley Lightening, Benoni (ZA); Seth Alaric Peters, Germiston (ZA)

Correspondence Address: MORGAN, LEWIS & BOCKIUS LLP (SF), One Market, Spear Street Tower, Suite 2800, San Francisco, CA, 94105, US

(21) Appl. No.: 11/577,789

(22) PCT Filed: Oct. 24, 2005
(86) PCT No.: PCT/IB05/03158

§ 371 Date: Dec. 18, 2008

(30) Foreign Application Priority Data
Oct. 22, 2004 (ZA) 2004/8583

(51) Int. Cl. G01N 21/55; G01N 21/00; G01J 3/46

(52) U.S. Cl. 356/445; 252/408.1; 356/402

(57) ABSTRACT

This invention relates to a method for the identification of an article, the method including the step of applying at least one identification particle to the article, wherein the identification particle on the article is not evident to the casual observer, but is evident on close inspection of the article, preferably with the naked eye. The identification particle is less than 500 microns in size and is reflective and has lustre. The reflective particle is not evident to the casual observer, but the sparkle thereof picked up by the naked eye on careful inspection.

### BACKGROUND OF THE INVENTION

THIS invention relates to a method and composition for the identification of articles.

Millions of Rands worth of fresh produce is stolen every year in South Africa. The produce is often stolen directly from farmers. The problem experienced is that once the produce is stolen, it is virtually impossible to identify the produce and the situation can occur where the produce is sold right outside the farm from which it was stolen.

It is an object of the present invention to provide a method and composition for identification of articles such as stolen produce or other plants, animals, and other articles.

### SUMMARY OF THE INVENTION

According to a first aspect of the invention there is provided a method for the identification of an article, the method including the step of applying at least one identification particle to the article, wherein the identification particle on the article is not evident to the casual observer, but is evident on close inspection of the article, preferably with the naked eye.

Preferably, the identification particle is applied as a discrete particle, i.e. it is applied as an individual particle and is not in contact with another identification particle.

The identification particle is typically less than 500 microns in size, preferably less than 400 microns in size, most preferably from 1 to 300 microns in size.

Preferably, the identification particle is reflective and has lustre.

Advantageously, the particle is planar, preferably in the form of a flake or a platelet.

According to a preferred embodiment of the invention, the particle is a pigment that reflects light, such as pearlescent pigment or metal effect pigment, most preferably a pearlescent pigment.

The method may include applying a plurality of identification particles to the article. Different colour combinations of identification particles may be applied to an article, to identify the article.

The method may also include applying a forensic component to the article.

According to a second aspect of the invention there is provided a liquid composition for use in a method of the identification of an article, the composition including a suspension of identification particles.

The composition typically includes a suspension agent/thickener and preferably also includes a preservative and a biocide.

The identification particles are typically less than 500 microns in size, preferably less than 400 microns in size, most preferably from 1 to 300 microns in size.

Preferably, the identification particles are reflective and have lustre.

Advantageously, the identification particles are planar, preferably in the form of a flake or a platelet.

According to a preferred embodiment of the invention, the identification particles are pigments that reflect light, such as pearlescent pigments or metal effect pigments.

Different colour combinations of pigment particles may be included in the composition.

The composition may also include a forensic component.

The composition may be water-based and/or contain hydrocarbons such as a wax.

Where the composition is water-based, the composition preferably includes an adherent such as a food grade cellulose derivative or styrene acrylate co-polymer.

A third aspect of the invention relates to the use of particles, preferably reflective particles that have luster such as a pearlescent pigment particles and/or metal effect pigment particles in the manufacture of a liquid composition for use in a method of the identification of an article, wherein the particles are applied discretely to the article.

A fourth aspect of the invention relates to an article having at least one identification particle on the surface of the article, wherein the identification particle on the surface of the article is not evident to the casual observer, but is evident on close inspection of the article, preferably with the naked eye.

### DESCRIPTION OF PREFERRED EMBODIMENTS

This invention relates to a method and composition for the identification of articles.

According to the invention, at least one discrete identification particle is applied to the article, so that the particle on the article is not evident to the casual observer, but is evident on close inspection of the article. This provides an overt identification mechanism that is not readily evident to a casual observer.

The identification particle is preferably reflective and has lustre, so that it sparkles/shines when it is viewed. The preferred particle is also coloured and planar (preferably a flake or platelet) preferably a colour pigment such as a pearlescent pigment or metal lustre pigment (which are described in more detail at pages 12-31 from “Special Effect Pigments” by Dr Ralf Glausch, Dr Manfred Kieser, Dr Roman Maisch, Dr Gerhard Pfaff, Joachim Weitzel, 1998, published by Curt R. Vincentz Verlag, Hannover, the content of which is incorporated herein by reference). These pigments almost completely reflect incident light and provide a lustre, as opposed to an absorption pigment which is based on absorption and/or diffuse scattering of light. Typically, the identification particle is less than 500 microns, preferably less than 400 microns, most preferably from 1 to 300 microns in size. Depending on size, type, surface and colour of the article, bigger or smaller, higher or lower concentrations and different colours of the identification particles are applied to the article, as discrete particles, to ensure that the identification particles are not evident to the casual observer, but are evident on close inspection.

The crux of the invention is that the particles are not evident to a casual observer, but are evident under close inspection of the article, preferably with the naked eye. The advantage is that an ordinary user of the article, for example somebody buying fresh produce, will not know that the article has been marked. In the case of fresh produce, evident markings on an article may deter a user from buying the produce. Another advantage is that thieves would not necessarily be able to tell that the article has been marked, and it would be easier to catch a thief in possession of a stolen article. On the other hand, an informed person who knows what he/she is looking for is able to identify the article with the naked eye on close inspection, and can thus identify stolen articles in the field. In this regard, such a person will hold the article in a normal white light, typically sunlight, and turn the article in his or her hand, and the naked eye will pick up the sparkling reflective particle/s.

Typically, the identification particles are applied to an article from a liquid composition which is sprayed onto the article. The composition may be water-based and/or contain hydrocarbons such as a wax. In a preferred embodiment of the invention, the composition is water-based and the particles are pearlescent pigment particles. In the case of edible produce, food-grade particles are used. Pearlescent particle compositions typically comprise titanium dioxide, iron oxide and an anti-caking agent such as potassium aluminium silicate. Typical standard pearlescent colour compositions are the products Candurin™ Gold Shimmer 120604, Candurin™ Wine Red Sparkle 120622 and Candurin™ Silver Luster 120602, available from Merck KgaA. The aforementioned pigment compositions may be mixed at a selected ratio to provide an identifiable security code. For example, a composition comprising 50% by weight Candurin™ Wine Red composition and 50% by weight Candurin™ Gold Shimmer composition is prepared. This composition is then formed into a water-based dispersion containing 1 part composition to 20 parts water, and a food-grade cellulose derivative is also added to provide a concentrate dispersion of the invention for use in the identification of articles such as fresh produce. The concentrate may be sold to end-users who will make up an end-use composition by adding 1 part concentrate to 100 parts water. In a preferred embodiment of the invention, the liquid composition includes a suspending agent/thickener, to ensure that the pigment particles are suspended in the liquid, as well as a preservative and a biocide. The concentrate is diluted and an end-use composition is then sprayed onto articles. The pearlescent particles are in the form of flakes which cling to the articles. The attachment of the pearlescent to the article is aided by the food grade cellulose derivative which acts as an adherent. An alternative adherent would be a styrene acrylate co-polymer such as Agripol™ 711 available from Kannar CC in South Africa.

Once the presence of the particles on the article has been identified with the naked eye, it may be necessary to identify the colours using a magnification device such as a microscope. This can then provide an overt identification of the article in the field.

Advantages of the composition and method of the present invention are that the composition is relatively inexpensive and convenient to apply to an article. For example, the composition can be sprayed onto fresh produce in the field before it has been harvested. Once the composition has been applied it is not readily evident to a casual observer and therefore purchasers of legitimate articles will not be “put off” by markings on the articles. It is, nevertheless, relatively easy to identify the pressure of particles on the article on careful inspection in the field.

For the purposes of identifying stolen goods, and for evidence that can be used in legal proceedings, a forensic component may also be included in the composition. Once the composition has been identified on an article by close inspection, the article can then be taken to a forensic laboratory and analyzed, which will provide further evidence which can be used in legal proceedings. This composition may be used for fresh produce described above, but also has further applications in identifying stolen plants, especially valuable or rare plants such as cycads.

In a further embodiment of the invention, the compositions as described above may be used to identify stolen animals such as cattle sheep. An adherent such as a food grade cellulose derivative is included to help the pigments and forensic components to adhere to the animal. A compound that fluoresces under UV light may also be included in the composition. Once the composition has been applied to the animal, the location of the composition may be identified on the animal by shining a UV light on the animal. Once the location of the composition has been identified, closer inspection or inspection under a magnifying device will identify the composition and thus the animal.

The method and composition of the invention are not limited to the articles mentioned above, and may be used for any article. It may be used for example in the packaging industry to mark packages of tobacco or champagne; in the textile industry to mark clothing; it may even be included in liquid compositions such as pesticides.

The invention will now be described in more detail with reference to the following to the following non-limiting Examples.

### Example 1

A general example of a concentrate suspension of the invention for use in a method for the identification of an article includes:

| | | |
|---|---|---|
| A suspending agent/thickener | 0.001 to 0.01% | m/v |
| such as Xanthan Gum | | |
| A preservative such as Potassium | 0.001 to 0.01% | m/v |
| Sorbate | | |
| A preservative | 0.001 to 0.01% | m/v |
| such as Sodium Metabisulfate | | |
| A biocide such as Vantocil IB | 0.0001 to 0.001% | m/v |
| A pearlescent pigment such as | 0.02 to 0.1% | m/v |
| Candurin ™ available from Merck KGaA. | | |
| A preservative | 0.0001 to 0.001% | m/v |
| such as Di Ammonium Phosphate | | |

| | |
|---|---|
| Deionized water | to volume. |

In addition to the above, the composition may include a forensic component.

### Example 2

A specific example of a concentrate suspension of the invention for use in a method for the identification of an article includes:

| | | |
|---|---|---|
| Deionised Water | 1000 | ml |
| Xanthan Gum | 5 | g |
| Potassium Sorbate | 2 | g |
| Sodium Metabisulfate | 2 | g |
| Vantocil IB | 0.5 | g |
| Candurin ™ Pigment | 20 to 100 | g |
| Di Ammonium Phosphate | 0.5 | g. |

### Example 3

The composition of Example 2 may be formulated to provide a concentrate suspension of the pigment in the aqueous solution. This concentrate suspension may then be sold to end-users for dilution with water at a ratio of 1:100. The diluted solution is then applied at a spray rate and using spray apparatus to suit the article and the conditions under which the spraying takes place to ensure that the pigment particles are not evident to the casual observer, and that they can be viewed on the article on close inspection on the article to which they are applied: Examples of the desired results of spraying are provided below. The fresh produce is preferably sprayed 2 weeks prior to harvest. For orchards, for example pecan nuts, a mist blower may be used to spray the composition. Alternatively, individual items, such as avocado, may be spot-sprayed using a knapsack sprayer. Pigment coated seeds may be sprayed before bagging with a liquid aqueous solution to provide 20 g of particles per ton of seed.

| | Pigment Particle | Concentration of |
|---|---|---|
| Article | Size/Microns | Particles on Article |
| Small fresh produce - | 10-60 | 1-5 particles per item |
| having an area of less | | |
| than 10 cm² e.g | | |
| Medium fresh produce - | 10-60 | 10-100 particles per |
| having an area of 10- | | item |
| 400 cm² e.g. avocado, | | |
| mandarin and apple | | |
| Large fresh produce - | 10-60 | 100-1000 Particles per |
| having an area of greater | | item |
| than 400 cm² e.g. | | |
| watermelon | | |
| Pigment coated seeds | 150 | 1-5 particles per item |
| Animals | 100-300 | A spray of 5 ml |
| | | solution on each animal |

1-38. (canceled)

39. A method for the identification of an article, the method including the step of applying a plurality of identification particle flakes or platelets that have a size of from 1-300 microns and that are reflective and have lustre, as discrete particles to the article, so that the identification particles on the article are not evident to the casual observer, but are evident on close inspection of the article with the naked eye under normal white light.

40. The method according to claim 39, wherein the identification particles are applied from an end-use liquid composition having a concentration of 0.0002 to 0.001 weight % particles.

41. The method according to claim 40, wherein the liquid composition is applied by spraying.

42. The method according to claim 39, wherein the identification particles are pigment particles.

43. The method according to claim 42, wherein the identification particles are pearlescent pigment particles.

44. The method according to claim 39, wherein the article has a surface area of less than 10 cm² and wherein 1 to 5 identification particles are applied to the article.

45. The method according to claim 39, wherein the article has a surface area of 10-400 cm², and 10 to 100 identification particles are applied to the article.

46. The method according to claim 39, wherein the article has a surface area greater than 400 cm², and 100-1000 identification particles are applied to the article.

47. The method according to claim 39, wherein different colour combinations of identification particles are applied to an article, to identify the article.

48. The method according to claim 40, wherein a forensic component is included in the liquid composition and applied to the article.

49. A liquid composition for use in a method of the identification of an article, the composition including a suspension of identification particle flakes or platelets that have a size of from 1-300 microns and that are reflective and have lustre.

50. The composition according to claim 49, including a suspension agent/thickener.

51. The composition according to claim 49, including a preservative and a biocide.

52. The composition according to claim 49, wherein the identification particles are pigment particles.

53. The composition according to claim 52, wherein the identification particles are pearlescent pigment particles.

54. The composition according to claim 49, wherein different colour combinations of identification particles are included in the composition.

55. The composition according to claim 54, wherein composition includes a forensic component.

56. The composition according to claim 49, wherein the composition is water-based.

57. The composition according to claim 56, wherein the composition contains a hydrocarbon.

58. The composition according to claim 57, wherein the hydrocarbon is a wax.

59. The composition according to claim 56, wherein the composition includes an adherent.

60. The composition according to claim 59, wherein the adherent is a food grade cellulose derivative or a styrene acrylate co-polymer.

61. The composition according to claim 49, wherein the composition is an end-use composition comprising the identification particles at a concentration of 0.0002 to 0.001 weight %.

62. The use of identification particle flakes or platelets that have a size of from 1-300 microns and that are reflective and have luster in the manufacture of a liquid composition for use in a method of the identification of an article, wherein the identification particles are applied discretely to the article, so that the identification particles on the article are not evident to the casual observer, but are evident on close inspection of the article with the naked eye under normal white light.

63. A method for the identification of an article, the method including the step of a applying at least one identification particle to the article, wherein the identification particle on the article is not evident to the casual observer, but is evident on close inspection of the article, characterized in that the identification particle is a food-grade particle.

64. A liquid composition for use in the method of identification of an article, the composition including a suspension of identification particles, characterized in that the identification particles are food-grade.
